(19) United States
(12) Patent Application Publication
(10) Pub. No.: US 2024/0182685 A1
(43) Pub. Date: Jun. 6, 2024

(54) POLYAMIDE COMPOSITIONS

(71) Applicant: LANXESS DEUTSCHLAND GMBH, Köln (DE)

(72) Inventors: Jochen ENDTNER, Köln (DE); Matthias BIENMÜLLER, Krefeld (DE)

(21) Appl. No.: 18/551,785

(22) PCT Filed: Nov. 2, 2021
(86) PCT No.: PCT/EP2021/080419

§ 371 Date: Sep. 21, 2023

(30) Foreign Application Priority Data
Mar. 26, 2021 (EP) 21165201.1

(51) Int. Cl. C08K 5/5317; C08K 5/5313; C08K 7/14

(52) U.S. Cl. CPC C08K 5/5317; C08K 5/5313; C08K 7/14

(57) ABSTRACT

The present invention relates to compositions on the basis of at least one polyamide that contains at least one aluminum salt of an organic phosphorus compound of the general formula (I)

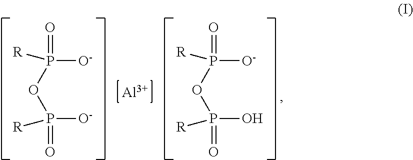

and at least one organic salt of phosphinic acid and/or at least one salt of diphosphinic acid, to a process preparing them and to their use.

The present invention relates to compositions and products based on at least one polyamide containing at least one aluminum salt of an organic phosphorus compound of the general formula (I)

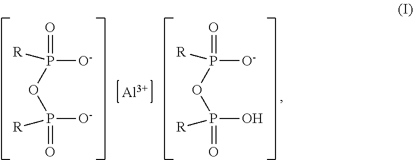

and at least one organic phosphinic acid salt and/or at least one diphosphinic acid salt, a process for their preparation and their uses.

### PRIOR ART

Due to their good mechanical stability, chemical resistance and good processability, polyamides are an important material, for example, for use in motor vehicles, in components for the electrical and electronics industry or in household appliances. When polyamides are used in the vicinity of current carrying parts, flame-retardant materials are often used to counteract the risk of origination of fire caused by overheated wires or contacts. Depending on the area of application, not only good self-extinguishing properties, in particular a UL94 V-0 classification according to Underwriters Laboratories Inc. Standard of Safety, “Test for Flammability of Plastic Materials for Parts in Devices and Appliances”, p. 14 to p. 18 Northbrook 1998, but also low flammability are required. For example, IEC60335-1 requires a glow wire test in accordance with IEC60695-2-11 on the finished part for components in unattended household appliances that are within 3 mm of current carrying parts with currents >0.2 A. Here, at a glow wire temperature of 750° C., there must be no flame appearance for more than 2 seconds. Experience has shown that test results on the finished part do not directly correspond to test results carried out in accordance with IEC60695-2-13 on a defined round plate at the same glow wire temperature due to undefined geometry of finished parts or also metal contacts impairing the heat flow, especially since in accordance with IEC60695-2-13 a test specimen is still regarded as not ignited if it shows a flame appearance of less than 5 seconds. Thus, according to IEC60695-2-13, the classification “GWIT 775° C.” is assigned if 3 test plates in a row measured at 750° C. show no flame appearance>5 seconds.

In order to be able to ensure that a material does not show any flame with a burning time longer than 2 seconds, even on the finished part and regardless of the geometry, even at 750° C. glow wire temperature, there is an increasing demand for materials that have a larger safety buffer in a plate test according to IEC60695-2-13, i.e. that beyond the standard requirements of IEC60335-1, a GWIT completely without ignition, i.e. a burning time of 0 seconds, or alternatively a GWIT above 775° C. is also passed.

In the field of polyamides, halogen-free solutions have recently been increasingly demanded, which, in addition to ecological reasons, is also due to the fact that halogen-free flame-retardant polyamides generally have a lower density and higher tracking resistance according to IEC60112-2010 compared to halogen-containing systems. Both play an important role, particularly in drive systems for electromobility.

However, high impact strength combined with high strength and stiffness is also essential for widespread use in technical applications, which allows the designer to achieve component arrangements that save material and thus also weight and conserve resources.

The desire for maximum design freedom and thus greater complexity of component geometry, in conjunction with the cost-driven need for series production processes that can be automated and easily integrated, is increasingly calling for materials that can also be joined together using the laser transmission welding process [https://de.wikipedia.org/wiki/Laserdurchstrahlschwei%C3%9Fen]. For a laser-transparent joining partner, this requires a high transmittance at the laser wavelength to be applied. The latter is a major challenge, especially for flame-retardant polyamides, since flame retardants scatter or even absorb the laser light, as is the case, for example, with antimony trioxide, which is commonly used as a synergist in halogen-containing flame retardants.

### PRIOR ART

To improve flame retardancy, polyamides are equipped with flame retardants. EP 0 792 912 A2 describes calcium or aluminum salts of ethyl-methylphosphinic acid, of ethane-1,2-bismethylphosphinic acid and of methyl-propylphopshinic acid, and finally the aluminum salt of methyl-octylphosphinic acid. Compounds reinforced with 30 wt. % glass fibers without further additives such as processing stabilizers were produced from polyamide 66 and 30 wt. % calcium salt and aluminum salt of ethyl methylphosphinic acid, respectively, from which test specimens were injected and subjected to the UL 94 fire test. Both the calcium salt and the aluminum salt of ethylmethylphosphinic acid achieved a V0 classification with a wall thickness of 1.6 mm and 1.2 mm.

However, modern applications in products for electromobility, for household appliances and in the electronics and electrical sector also require a UL94 V0 classification, even for thinner wall thicknesses, and furthermore, beyond a VO classification, in the meantime the existence of further technical specifications or regulations with regard to fire protection and mechanics. Based on EP 0 792 912 A2, the object of the present invention was therefore to provide halogen-free flame-retardant, reinforced polyamide compositions with the potential for a UL94 V0 classification and at the same time very good performance in the glow-wire ignition test, very good impact strength and, in particular, a high laser transmission for the purpose of applicability for the laser transmission welding process, especially with regard to applications and products for electromobility, for household appliances and in the electronics and electrical sector. With respect to the specifications of EP 0 792 912 A2, compositions according to the invention should achieve the V0 classification according to Underwriters Laboratories Inc. Standard of Safety, “Test for Flammability of Plastic Materials for Parts in Devices and Appliances”, p. 14-18 Northbrook 1998 even with wall thicknesses of only 0.75 mm, or at least show no deterioration in direct comparison with the compositions of EP 0 792 912 A2.

It has now been surprisingly found that the combination of at least one phosphorus-containing aluminum salt of the general formula (I)

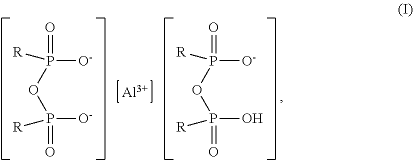

wherein R represents C₁-C₁₂ alkyl, with at least one organic metal phosphinate or diphosphinic acid salt in reinforced polyamide 66 based polymer compositions and products to be made therefrom, fulfills the above complex purpose.

The IZOD impact strength according to DIN EN ISO 180 used in the present invention to obtain mechanical characteristic values can be used for rigid thermoplastic injection molding and extrusion molding compounds, thermoset materials and thermotropic liquid crystalline polymers, as well as for filled and reinforced materials. The impact energy E_{c} of an unnotched specimen determined at a fracture is related to the initial cross-sectional area of the specimen according to the following equation:

$${a}_{iU} = \frac{{E}_{c}}{h \cdot b}$$

where a_{iU}=impact strength, h=thickness and b=width.

The test specimens to be used for this purpose can be manufactured according to the corresponding molding compound standard or by pressing and injection molding, or they can be taken from multi-purpose test specimens (DIN EN ISO 527 [2]). The dimensions of the unnotched test specimen according to DIN EN ISO 3167, type A, used in the present invention are:
Length I=(80±2) mm
Width b=(10.0±0.2) mm
Thickness h=(4.0±0.2) mm

See here:

https://wiki.polymerservice-merseburg.de/index.php/Schlagbiegeversuch

According to the invention, a high laser transmission is a laser transmission of at least 30%, preferably at least 40%, particularly preferably at least 50% measured on platelets with a thickness of 0.75 mm with the transmission measuring instrument LPKF TMG3 from LPKF Laser & Electronics AG, Garbsen, Germany at a laser wavelength of 980 nm. The LPKF TMG3 transmission meter is a certified, traceably calibrated measuring instrument. Its measurement capability was proven in a statistical measurement system analysis (MSA). The instrument also complies with the specifications of the automotive standard IATF 16949 and is thus directly qualified for quality assurance in compliance with the standard. The measurements within the scope of the present invention are carried out on the basis of DVS guideline 2243 (01/2014) “Laser beam welding of thermoplastics” using round plates with a diameter of 80 mm and a thickness of 0.75 mm in the near infrared (NIR). The LPKF TMG3 transmission meter from LPKF Laser & Electronics AG is calibrated prior to the measurements using a measurement standard generated in accordance with DIN EN ISO/IEC 17025. In the context of the present invention, the measurements are carried out at a laser wavelength of 980 nm.

### SUBJECT OF THE INVENTION

Subject matter of the invention are polymer compositions containing
A) per 100 parts by mass of polyamide 66,
B) 2 to 100 parts by mass, preferably 5 to 60 parts by mass, especially preferred 7 to 40 parts by mass, in particular preferred 8 to 20 parts by mass, of at least one aluminum salt of the general formula (I)

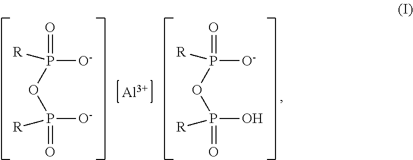

wherein R represents C₁-C₁₂ alkyl, preferably methyl, ethyl, isopropyl or iso-butyl, tert-butyl or n-butyl, more preferably ethyl or methyl, most preferably methyl, and
C) 5 to 120 parts by mass, preferably 7 to 80 parts by mass, particularly preferably 8 to 60 parts by mass, especially preferably 10 to 50 parts by mass of at least one organic phosphinic acid salt of the formula (II) and/or at least one diphosphinic acid salt of the formula (III) and/or polymers thereof,

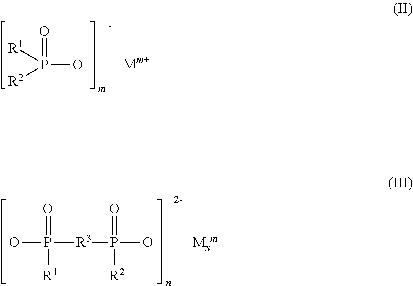

wherein
   R¹, R² are the same or different and represent a linear or branched C₁-C₆-alkyl, and/or C₆-C₁₄-aryl,
   R³ represents a linear or branched C₁-C₁₀-alkylene, C₆-C₁₀-arylene or a C₁-C₆-alkyl-C₆-C₁₀-arylene or C₆-C₁₀-aryl-C₁-C₆-alkylene,
   M represents aluminum, zinc or titanium,
   m represents an integer from 1 to 4;
   n represents an integer from 1 to 3,
   x represents 1 and 2,
   wherein n, x and m in formula (III) can simultaneously represent only such integers, that the diphosphinic acid salt of formula (III) as a whole is uncharged, and
D) 3 to 300 parts by mass, preferably 5 to 200 parts by mass, particularly preferably 15 to 120 parts by mass, especially preferably 20 to 90 parts by mass of at least one filler and/or reinforcing material.

Subject-matter of the present invention are also products based on the compositions according to the invention, in particular products for electromobility, for household appliances and in the electronics and electrical sector.

However, the present invention also relates to the use of from 2 to 100 parts by mass, preferably from 5 to 60 parts by mass, particularly preferably from 7 to 40 parts by mass, more preferably from 8 to 20 parts by mass of at least one aluminum salt of the general formula (I)

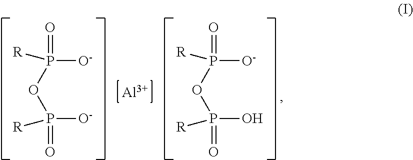

wherein R represents C₁-C₁₂ alkyl, preferably methyl, ethyl, isopropyl or iso-butyl, tert-butyl or n-butyl, more preferably ethyl or methyl, most preferably methyl, and
5 to 120 parts by mass, preferably 7 to 80 parts by mass, particularly preferably 8 to 60 parts by mass, especially preferably 10 to 50 parts by mass of at least one organic phosphinic acid salt of the formula (II) and/or at least one diphosphinic acid salt of the formula (III) and/or polymers thereof,

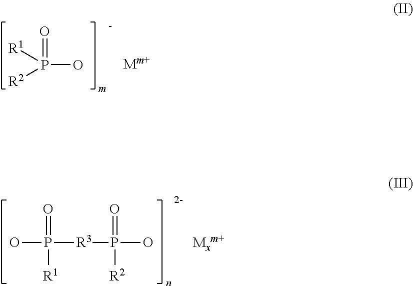

wherein
R¹, R² are the same or different and represent a linear or branched C₁-C₆ -alkyl, and/or C₆-C₁₄-aryl,
R³ represents linear or branched C₁-C₁₀-alkylene, C₆-C₁₀-arylene or represents C₁-C₆-alkyl-C₆-C₁₀-arylene or C₆-C₁₀-aryl-C₁-C₆-alkylene,
   M represents aluminum, zinc or titanium,
   m represents an integer from 1 to 4;
   n represents an integer from 1 to 3,
   x represents 1 and 2,
wherein n, x and m in formula (III) can simultaneously represent only such integers, that the diphosphinic acid salt of formula (III) as a whole is uncharged, in each case based on 100 parts by mass of polyamide 66 which is reinforced with 3 to 300 parts by mass, preferably 5 to 200 parts by mass, particularly preferably 15 to 120 parts by mass, more preferably 20 to 90 parts by mass of at least one filler and/or reinforcing material, for the production of laser-transparent compositions or products, preferably also with a GWIT at 0.75 mm wall thicknesses of at least 775° C.

The preparation of polyamide 66-based polymer compositions according to the invention for use in products in the field of electromobility, in household appliances and in the electronics and electrical sector, is carried out by mixing components A), B), C) and D), to be used as starting materials, in at least one mixing tool in the mass ratios given above. As a result of the mixing, molding compounds based on the polymer compositions of the invention are obtained as intermediates. These molding compounds can either consist exclusively of components A), B), C) and D) or additionally contain at least one further component. In the case that laser-transparent polymer compositions are to be provided, further components are to be selected in such a way that laser-absorbing additives are omitted.

It is also an object of the present invention to provide a process for the manufacture of products, preferably products for electromobility, for household appliances and in the electronics and electrical sectors, by mixing or blending component A) 100 parts by mass of polyamide 66 with
B) 2 to 100 parts by mass, preferably 5 to 60 parts by mass, particularly preferably 7 to 40 parts by mass, especially preferably 8 to 20 parts by mass, of at least one aluminum salt of the general formula (I)

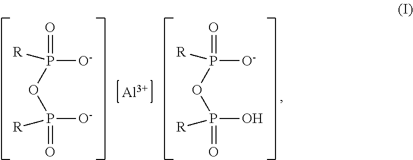

wherein R represents C₁-C₁₂ alkyl, preferably methyl, ethyl, isopropyl or iso-butyl, tert-butyl or n-butyl, more preferably ethyl or methyl, most preferably methyl, and
C) 5 to 120 parts by mass, preferably 7 to 80 parts by mass, particularly preferably 8 to 60 parts by mass, especially preferably 10 to 50 parts by mass, of at least one organic phosphinic acid salt of the formula (II) and/or at least one diphosphinic acid salt of the formula (III) and/or polymers thereof,

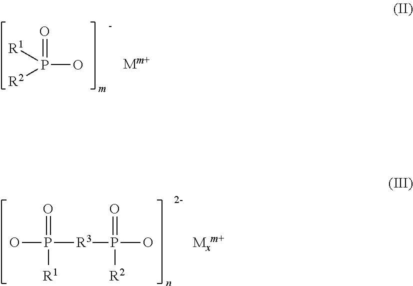

wherein
R¹, R² are the same or different and represent a linear or branched C₁-C₆-alkyl, and/or C₆-C₁₄-aryl,
R³ represents linear or branched C₁-C₁₀-alkylene, C₆-C₁₀-arylene or represents C₁-C₆-alkyl-C₆-C₁₀-arylene or C₆-C₁₀-aryl-C₁-C₆-alkylene,
   M represents aluminum, zinc or titanium,
   m represents an integer from 1 to 4;
   n represents an integer from 1 to 3,
   x represents 1 and 2,
wherein n, x and m in formula (III) can simultaneously represent only such integers, that the diphosphinic acid salt of formula (III) as a whole is uncharged, and with
D) 3 to 300 parts by mass, preferably 5 to 200 parts by mass, particularly preferably 15 to 120 parts by mass, especially preferably 20 to 90 parts by mass, of at least one filler and/or reinforcing material and, optionally, with further additives, in at least one mixing unit and finally process it in injection molding. Preferably, the components are kneaded, compounded, extruded or rolled to form a molding compound. Preferably, this mixing is carried out at a temperature in the range of 270 to 300° C., particularly preferably by compounding on a co-rotating twin-screw extruder or Buss Kneader. It may be advantageous to pre-mix individual components.

For the sake of clarification, it should be noted that the scope of the present invention encompasses all of the listed general definitions and parameters or those mentioned in preferred sections in any combination. This relates in particular to the stated mass fractions with respect to the polymer compositions, the use(s) described in accordance with the invention and the processes described in accordance with the invention. The standards mentioned in the context of this application refer to the version applicable as of the filing date of this invention. An aryl group (abbreviated: Ar) is an organic chemical rest with an aromatic backbone. Aryl is thus the general name for a monovalent atomic group derived from aromatic hydrocarbons by removal of a hydrogen atom attached to the ring. Most aryl rests are derived from benzene (C₆H₆), and the simplest aryl group is the phenyl group (Ph), (—C₆H₅). Aryl rests can occur either as a fragment of a molecule or as an unstable free radical.

### Other Preferred Embodiments of the Invention

In a further preferred embodiment, the invention also relates to polymer compositions comprising, in addition to components A) to D), at least one further additive different from components B), C) and D), preferably from 0.01 to 100 parts by mass, particularly preferably from 0.05 to 50 parts by mass, very particularly preferably from 0.1 to 30 parts by mass, in each case related to 100 parts by mass of component A), with the proviso that laser absorbers are omitted to maintain laser transparency.

### Component A)

The polyamide 66 [CAS No. 32131-17-2] to be used according to the invention as component A) in the context of the present inventions preferably has a viscosity number to be determined according to ISO 307 in 0.5% by weight solution in 96% by weight sulfuric acid at 25° C. in the range from 90 to 180 ml/g, particularly preferably in the range from 100 to 165 ml/g and most preferably in the range from 110 to 140 ml/g. Polyamide 66 (poly-(N,N′-hexamethylene adipindiamide)poly-(hexamethylene adipamide), which is preferred as component A) according to the invention, is available, for example, as Ultramid® A24E01 from BASF SE, Ludwigshafen.

The identification of the polyamides used in the present application is in accordance with the international standard ISO 1874-1, where the first digit(s) indicate the C atomic number of the starting diamine and the last digit(s) indicate the C atomic number of the dicarboxylic acid. If two numbers are given, as in the case of polyamide 66 (PA66), this means that a dicarboxylic acid, i.e. adipic acid in the case of PA 66, has been assumed, which has been reacted with hexamethylenediamine.

The polyamide 66 to be used as component A) according to the invention can also be used in a blend with at least one other polyamide and/or at least one other polymer. Therefore, all copolyamides based on polyamide 66 are also included according to the invention. Preferred other polymers are selected from the group consisting of polyethylene, polypropylene and acrylonitrile-butadiene-styrene copolymer (ABS). In the case of the use of at least one other polyamide or at least one other polymer, this is preferably or optionally carried out using at least one compatibilizer.

The polyamide 66 to be used as component A) can be mixed with conventional additives, preferably demolding agents, stabilizers and/or flow aids known to the skilled person, already in the melt.

### Component B)

At least one aluminum salt of the general formula (I) is used as component B) to be used according to the invention,

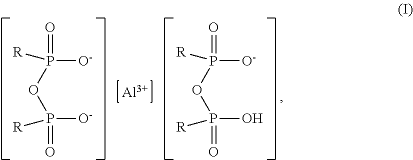

wherein R is C₁-C₁₂ alkyl, preferably methyl, ethyl, isopropyl or iso-butyl, tert-butyl or n-butyl, more preferably ethyl or methyl, most preferably methyl.

These aluminum salts of organic phosphorus compounds with the general formula (I), which are to be used according to the invention as component B) within the scope of the present invention, can be prepared by various processes and synthesized from different building blocks. In the context of the present invention, the following process is used for the preparation of compound (Ia) with R=methyl:

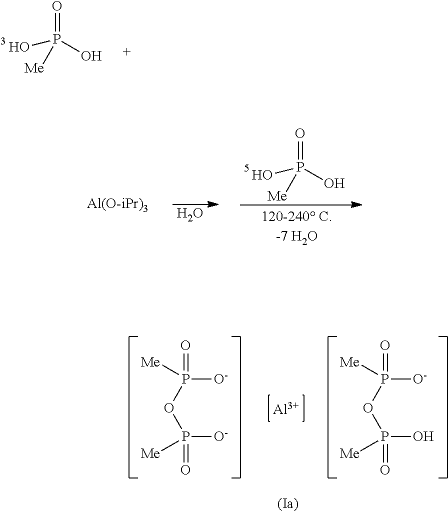

A reaction vessel is charged with 83 g of methylphosphonic acid and heated to 120° C. An intermediate prepared from 50 g methylphosphonic acid and 35.4 g aluminum tris(isopropoxide) is added to the reaction vessel in the presence of water. The resulting solution, which contains methylphosphonic acid and aluminum methylphosphonate in a molar ratio of 5:1 as intermediates, is heated to 240° C. with mechanical stirring. Stirring is continued at 240° C. for about 30 minutes until a solid is formed. Then 500 ml of water is added and this mixture is stirred for 16 h, meanwhile a uniform slurry is formed. The product is finally filtered off, washed with 750 ml of water and dried. The result is 64.3 g of the product of formula (Ia) to be used as component B) as fine colorless crystals at a yield of 93%. The empirical formula (Ia) represents repeating monomer units (i.e. coordination units) of a coordination polymer which is in crystal form.

Further methods, in particular for R≠Methyl can be found in WO 2020/132075 A1, the contents of which is fully encompassed by the present invention.

Particularly preferred is component B) according to formula (Ia) with a molar ratio of phosphorus to aluminum of 4:1 to be determined by ICP-OES elemental analysis, with needle-shaped crystals being particularly preferred. For this, see Example 3 in WO 2021/076169 A1 and for ICP-OES see: https://www.itmc.rwth-aachen.de/go/id/gden

### Component C)

As component C), the compositions according to the invention contain at least one phosphinic acid salt of the formula (II)

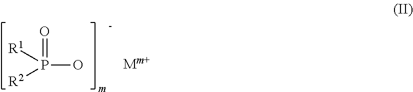

and/or at least one diphosphinic acid salt of the formula (III)

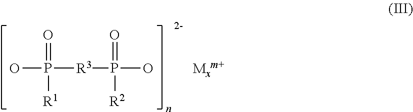

and/or polymers thereof. Phosphinic acid salts of formula (II) and diphosphinic acid salts of formula (III) are also referred to as phosphinates in the context of the present invention.

Preferably, M in the formulae (II) or (III) stands for aluminum. Preferably, R¹, R² in the formulae (II) and (III) are identical or different and represent C₁-C₆-alkyl, linear or branched and/or phenyl. Particularly preferably, R¹, R² are identical or different and represent methyl, ethyl, n-propyl, iso-propyl, n-butyl, tert-butyl, n-pentyl and/or phenyl.

Preferably, R³ in formula (III) represents methylene, ethylene, n-propylene, iso-propylene, n-butylene, tert-butylene, n-pentylene, n-octylene, n-dodecylene, phenylene, naphthylene, methyl-phenylene, ethylphenylene, tert-butylphenylene, methylnaphthylene, ethylnaphthylene, tert-butylnaphthylene, phenylmethylene, phenylethylene, phenylpropylene or phenylbutylene. Particularly preferably, R³ represents phenylene or naphthylene. Suitable phosphinates are described in WO-A 97/39053, the contents of which, with respect to phosphinates, are embraced by the present application. Particularly preferred phosphinates in the sense of the present invention are aluminum and zinc salts of dimethyl phosphinate, ethyl methyl phosphinate, diethyl phosphinate and methyl n-propyl phosphinate and mixtures thereof.

Preferably, m in formula (II) is 2 and 3, more preferably 3.

Preferably, n in formula (III) is 1 and 3, more preferably 3.

Preferably, x in formula (III) is 1 and 2, more preferably 2.

The most preferred component C) to be used is aluminum tris(diethylphosphinate) [CAS No. 225789-38-8], which is offered, for example, by Clariant International Ltd. Muttenz, Switzerland, under the trade name Exolit® OP1230 or Exolit® OP1240.

Preferably, component C) is used in lower mass proportions than component B).

### Component D)

Polymer compositions according to the invention contain as component D) at least one filler and/or reinforcing material. Mixtures of two or more different fillers and/or reinforcing materials can also be used.

Preferably, component D) is at least one filler and/or reinforcing material selected from the group consisting of carbon fibers [CAS No. 7440-44-0], glass spheres or solid or hollow glass spheres, glass fibers, ground glass, amorphous quartz glass, aluminum borosilicate glass with an alkali content of 1% (E-glass) [CAS No. 65997-17-3], amorphous silica [CAS No. 7631-86-9], quartz flour [CAS No. 14808-60-7], calcium silicate [CAS No. 1344-95-2], calcium metasilicate [CAS No. 10101-39-0], magnesium carbonate [CAS No. 546-93-0], kaolin [CAS No. 1332-58-7], calcined kaolin [CAS No. 92704-41-1], chalk [CAS No.1317-65-3], kyanite [CAS No. 1302-76-7], powdered or ground quartz [CAS No. 14808-60-7], mica [CAS No. 1318-94-1], phlogopite [CAS No. 12251-00-2], barium sulfate [CAS No. 7727-43-7], feldspar [CAS No. 68476-25-5], wollastonite [CAS No. 13983-17-0], montmorillonite [CAS No. 67479-91-8], pseudoboehmite of formula AlO(OH), magnesium carbonate [CAS No. 12125-28-9], and talc [CAS No. 14807-96-6] were used.

Among the fibrous fillers or reinforcing materials, glass fibers and wollastonite are particularly preferred, with glass fibers being especially preferred. In the case of a laser-absorbing component or laser-absorbing high-voltage component, carbon fibers can also be used as a filler or reinforcing material.

Particularly preferred is the use of glass as filler and/or reinforcing material as component D). Preferably, glass according to DIN1259-1 is used. Especially preferred, glass in the form of full or hollow glass spheres, glass fibers, ground glass or aluminum borosilicate glass with an alkali content of 1% (E-glass) [CAS No. 65997-17-3] is used.

With regard to glass fibers, according to “http://de.wikipedia.org/wiki/Faser-Kunststoff-Verbund” the skilled person distinguishes between chopped fibers, also referred to as short fibers, with a length in the range of 0.1 to 1 mm, long fibers with a length in the range of 1 to 50 mm and continuous fibers with a length L>50 mm. Short fibers are preferably used in injection molding and can be processed directly with an extruder. Long fibers can also still be processed in extruders. Continuous fibers are used as rovings or fabrics in fiber-reinforced plastics. Products with continuous fibers achieve the highest stiffness and strength values. Furthermore, milled glass fibers are offered, whose length after milling is typically in the range of 70 to 200 μm.

Preferred glass fibers to be used as component D) according to the invention are chopped long glass fibers with an average initial length in the range from 1 to 50 mm, particularly preferably in the range from 1 to 10 mm, even more preferred in the range from 2 to 7 mm.

Preferred glass fibers to be used as component D) have an average fiber diameter in the range from 7 to 18 μm, particularly preferably in the range from 9 to 15 μm. Scanning electron microscopy (SEM) can be used as a possible method for determining the fiber diameters (https://de.wikipedia.org/wiki/Rasterelektronenmikroskop).

According to a preferred embodiment, the glass fibers to be preferably used as component D) are equipped with a suitable sizing system or an adhesion promoter or adhesion promoter system. Preferably, a silane-based sizing system or adhesion promoter is used. Particularly preferred silane-based adhesion promoters for the treatment of the glass fibers to be used preferably as component D) are silane compounds of the general formula (IV)

(X—(CH₂)_{q})ₖ—Si—(O—CrH₂ᵣ₊₁)₄₋ₖ (IV)
wherein
X represents NH₂—, carboxyl-, HO— or

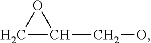

q in formula (IV) represents an integer from 2 to 10, preferably 3 to 4,
r in formula (IV) represents an integer from 1 to 5, preferably from 1 to 2, and
k in formula (IV) represents an integer from 1 to 3, preferably 1.

Particularly preferred adhesion promoters are silane compounds selected from the group consisting of aminopropyltrimethoxysilane, aminobutyltrimethoxysilane, aminopropyltriethoxysilane, aminobutyltriethoxysilane and the corresponding silanes which contain a glycidyl or a carboxyl group as substituent X in formula (IV), wherein carboxyl groups are particularly preferred.

For the equipment of the glass fibers to be used preferably as component D), the adhesion promoter, preferably the silane compounds according to formula (IV), is used preferably in amounts of 0.05 to 2% by weight, particularly preferably in amounts of 0.25 to 1.5% by weight and most preferably in amounts of 0.5 to 1% by weight, in each case based on 100% by weight of component D).

The glass fibers to be preferably used as component D) may be shorter in the composition or product than the glass fibers originally used due to the processing into the composition or product. Thus, the arithmetic mean value of the glass fiber length to be determined by means of high-resolution X-ray computer tomography after processing is frequently only in the range of 150 μm to 300 μm.

According to “http://www.r-g.de/wiki/Glasfasern”, glass fibers are produced by the melt spinning process (jet drawing, rod drawing and jet blowing processes). In the jet drawing process, the hot glass mass flows through hundreds of jet holes of a platinum spinning plate using gravity. The elementary filaments can be drawn in unlimited length at a speed of 3-4 km/minute.

The expert distinguishes between different types of fiberglass, some of which are listed here, for example:
E-glass, the most widely used material with optimal price-performance ratio (E-glass from R&G) with a composition according to https://www.r-g.de/wiki/Glasfasern of 53-55% SiO₂, 14-15% Al₂O₃, 6-8% B₂O₃, 17-22% CaO, <5% MgO, <1% K₂O or Na₂O and about 1% other oxides;
H-glass, hollow glass fibers for reduced weight (R&G hollow glass fiber fabric 160 g/m² and 216 g/m²);
R, S-glass, for increased mechanical requirements (S2-glass from R&G);
D-glass, borosilicate glass for increased electrical requirements;
C glass, with increased chemical resistance;
Quartz glass, with high temperature resistance.

Further examples can be found at “http://de.wikipedia.org/wiki/Glasfaser”. E-glass fibers have gained the greatest importance for plastic reinforcement. The “E” in E-glass stands for electro-glass, as it was originally used primarily in the electrical industry.

To produce E-glass, glass melts are made from pure quartz with additives of limestone, kaolin and boric acid. In addition to silicon dioxide, they contain varying amounts of different metal oxides. The composition determines the properties of the products. In accordance with the invention, at least one type of glass fiber from the group consisting of E-glass, H-glass, R,S-glass, D-glass, C-glass and quartz glass is preferred, wherein glass fibers of E-glass are particularly preferred.

E-glass fibers are the most widely used reinforcing material. The strength properties correspond to those of metals (e.g. aluminum alloys), although the specific weight of laminates containing E-glass fibers is lower than that of metals. E-glass fibers are incombustible, heat resistant up to approx. 400° C. and resistant to most chemicals and weathering.

Preferably, needle-shaped mineral fillers are also used as component D). According to the invention, needle-shaped mineral fillers are mineral fillers with a strongly pronounced needle-like character. The needle-shaped mineral filler to be preferably used as component D) is wollastonite. Preferably, the needle-shaped mineral filler has a length:diameter ratio, to be determined for example by means of scanning electron microscopy, in the range from 2:1 to 35:1, particularly preferably in the range from 3:1 to 19:1, especially preferably in the range from 4:1 to 12:1. The average particle size of the needle-shaped mineral fillers to be determined, for example, by scanning electron microscopy is preferably less than 20 μm, particularly preferably less than 15 μm, especially preferably less than 10 μm.

However, non-fibrous and non-foamed ground glass with a particle size distribution to be determined by laser diffraction in accordance with ISO 13320 with a d90 in the range from 5 to 250 μm, preferably in the range from 10 to 150 μm, particularly preferably in the range from 15 to 80 μm, very particularly preferably in the range from 16 to 25 μm is also used as component D). With regard to d90 values, their determination and their significance, reference should be made to Chemie Ingenieur Technik (72) pp. 273-276, 3/2000, Wiley-VCH Verlags GmbH, Weinheim, 2000, according to which the d90 value is the particle size below which 90% of the particle quantity lies. For laser diffraction particle sizing/laser diffractometry according to the ISO 13320 standard, see:

https://de.wikipedia.org/wiki/Laserbeugungs-Partikelgr%C3%B6%C3%9Fenanalyse

According to the invention, preferred is the non-fibrous and non-foamed ground glass having particulate, non-cylindrical shape and has a ratio of length to thickness, to be determined by laser diffraction according to ISO 13320, of less than 5, preferably less than 3, particularly preferably less than 2. The value zero is of course excluded.

The non-foamed and non-fibrous ground glass to be used as component D) in one embodiment is further characterized in that it does not have the glass geometry typical of fibrous glass with a cylindrical or oval cross-section with a length to diameter ratio (L/D ratio) greater than 5 to be determined, for example, by scanning electron microscopy.

The non-foamed and non-fibrous ground glass to be used as component D) in one embodiment according to the invention is preferably obtained by grinding glass with a mill, preferably a ball mill, and particularly preferably with subsequent sifting or screening. Preferred starting materials for the grinding of the non-fibrous and non-foamed ground glass to be used as component D) in one embodiment also include glass waste, such as being produced in particular during the manufacture of glass products as an unwanted by-product and/or as a main product not meeting specifications (so-called off-spec goods). This includes in particular waste, recycled and broken glass such as may be produced in particular in the manufacture of window or bottle glass, as well as in the manufacture of glass-containing fillers and reinforcing materials, in particular in the form of so-called melt cakes. The glass can be colored, whereby non-colored glass is preferred as starting material for use as component D).

### Component E)

At least one further additive different from components B), C) and D) is used as component E). Preferred additives to be used as component E) are antioxidants, thermostabilizers, UV stabilizers, -gamma ray stabilizers, hydrolysis stabilizers, antistatic agents, emulsifiers, nucleating agents, plasticizers, processing aids, impact modifiers, lubricants and/or mold release agents, water absorption reduction components, flow aids or elastomer modifiers, chain extending additives, flame retardants different from components B) and C), or colorants. The additives can be used alone or in mixtures or in the form of masterbatches. In the case of laser-transparent products, additives to be used as component E) should be selected so that no laser absorbers such as in particular carbon black are used. Laser-absorbing additives are sufficiently known to the skilled person.

Preferred thermostabilizers of component E) are sterically hindered phenols, in particular those containing at least one 2,6-di-tert-butylphenyl group and/or 2-tert-butyl-6-methylphenyl group, particularly preferably N,N′-1,6-hexanediylbis[3,5-bis(1,1-dimethylethyl)-4-hydroxyphenylpropanamide] [CAS No. 23128-74-7], available, for example, as Irganox 1098 from Fa. BASF, Ludwigshafen, Germany, further phosphites, hypophosphites, in particular sodium hypophosphite NaH₂PO₂, hydroquinones, aromatic secondary amines, substituted resorcinols, salicylates, benzotriazoles and benzophenones, 3,3′-thiodipropionic acid esters and variously substituted representatives of these groups or mixtures thereof.

In one embodiment, copper salts, preferably in combination with sodium hypophosphite NaH₂PO₂, can also be used as thermostabilizers of component E). Preferably, copper(I) iodide [CAS No. 7681-65-4] and/or copper(triphenylphosphino)iodide [CAS No. 47107-74-4] is used as copper salt. Preferably, the copper salts are used in combination with sodium hypophosphite NaH₂PO₂ or with at least one alkali iodide. Preferred alkali iodide is potassium iodide [CAS No. 7681-11-0].

Thermostabilizers to be used as component E) are preferably employed in amounts of 0.01 to 2 parts by mass, particularly preferably in amounts of 0.05 to 1 part by mass, in each case based on 100 parts by mass of component A).

UV stabilizers to be used as component E) are preferably substituted resorcines, salicylates, benzotriazoles and benzophenones, HALS derivatives (“hindered amine light stabilizers”) containing at least one 2,2,6,6-tetramethyl-4-piperidyl unit or benzophenones.

UV stabilizers to be used as component E) are preferably employed in amounts of 0.01 to 2 parts by mass, particularly preferably in amounts of 0.1 to 1 part by mass, in each case based on 100 parts by mass of component A).

Colorants to be used as component E) are preferably inorganic pigments, in particular ultramarine blue, bismuth vanadate, iron oxide, titanium dioxide, zinc sulfide, tin-titanium-zinc oxides [CAS no. 923954-49-8], furthermore organic colorants, preferably phthalocyanines, quinacridones, benzimidazoles, in particular Ni-2-hydroxy-napthyl-benzimidazole [CAS No. 42844-93-9] and/or pyrimidine-azo-benzimidazole [CAS No. 72102-84-2] and/or Pigment Yellow 192 [CAS No. 56279-27-7], furthermore perylenes, anthraquinones, in particular C.I. Solvent Yellow 163 [CAS No. 13676-91-0], whereby this list is not exhaustive and whereby the selection of the colorants has to be made with particular consideration of the requirements for laser transmission or laser absorption behavior.

In one embodiment, preferably in the case of a laser-absorbing component, carbon black and/or nigrosine are also used as colorants.

Nucleating agents to be used as component E) are preferably sodium or calcium phenyl phosphinate, aluminum oxide or silicon dioxide and, very preferably, talc, although this list is not exhaustive.

Preferably, copolymers of at least one α-olefin with at least one methacrylic acid ester or acrylic acid ester of an aliphatic alcohol are used as flow promoters to be used as component E). Copolymers in which the α-olefin is composed of ethene and/or propene and the methacrylic acid ester or acrylic acid ester contains linear or branched alkyl groups having 6 to 20 carbon atoms as the alcohol component are particularly preferred. Acrylic acid (2-ethyl)-hexyl ester is particularly preferred. Copolymers suitable as flow auxiliaries are characterized not only by their composition but also by their low molecular weight. Accordingly, copolymers which have an MFI value measured at 190° C. and a load of 2.16 kg of at least 100 g/10 min, preferably of at least 150 g/10 min, particularly preferably of at least 300 g/10 min, are particularly suitable for the compositions to be protected from thermal degradation according to the invention. The MFI, melt flow index, is used to characterize the flow of a melt of a thermoplastic and is subject to the standards ISO 1133 or ASTM D 1238. In particular, a copolymer of ethene and acrylic acid (2-ethyl)-hexyl ester with MFI 550, known as Lotryl® 37EH550, is preferably used as flow aid.

The preferred chain-extending additives to be used as component E) and as hydrolysis stabilizers are di- or polyfunctional branching or chain-extending additives containing at least two branching or chain-extending functional groups per molecule. Preferred branching or chain-extending additives are low molecular weight or oligomeric compounds which have at least two chain-extending functional groups per molecule which can react with primary and/or secondary amino groups, and/or amide groups and/or carboxylic acid groups. Chain-extending functional groups are preferably isocyanates, carbodiimides, alcohols, epoxides, maleic anhydride, oxazolines, oxazines, oxazolones, epoxides being preferred.

Particularly preferred di- or polyfunctional branching or chain-extending additives are diepoxides based on diglycidyl ethers (bisphenol and epichlorohydrin), based on amine epoxy resin (aniline and epichlorohydrin), based on diglycidyl esters (cycloaliphatic dicarboxylic acids and epichlorohydrin) individually or in mixtures, and 2,2-bis[p-hydroxy-phenyl]propane diglycidyl ethers, bis[p-(N-methyl-N-2,3-epoxy-propylamino)phenyl]methane and epoxidized fatty acid esters of glycerol containing at least two epoxide groups per molecule.

Particularly preferred di- or polyfunctional branching or chain-extending additives are glycidyl ethers, most preferably bisphenol A diglycidyl ether [CAS No. 98460-24-3] or epoxidized fatty acid esters of glycerol, and also most preferably epoxidized soybean oil [CAS No. 8013-07-8] and/or epoxidized linseed oil.

Preferred plasticizers to be used as component E) are phthalic acid dioctyl esters, phthalic acid dibenzyl esters, phthalic acid butyl -benzyl esters, hydrocarbon oils or N-(n-butyl)benzenesulfonamide.

Elastomer modifiers to be used preferably as component E) include, among others, one or more graft polymers of
E.1 5 to 95% by weight, preferably 30 to 90% by weight, of at least one vinyl monomer and
E.2 95 to 5% by weight, preferably 70 to 10% by weight, of one or more grafting bases having glass transition temperatures <10° C., preferably <0° C., particularly preferably <−20° C., the percentages by weight being based on 100% by weight of elastomer modifier.

The graft base E.2 generally has a mean particle size d50 value of 0.05 to 10 μm, preferably 0.1 to 5 μm, particularly preferably 0.2 to 1 μm, to be determined by laser diffraction according to ISO 13320.

Monomers to E.1 are preferably mixtures of
E.1.1 50 to 99% by weight of vinylaromatics and/or nucleus-substituted vinylaromatics, in particular styrene, α-methylstyrene, p-methylstyrene, p-chlorostyrene, and/or methacrylic acid (C₁-C₈)-alkyl esters, in particular. methyl methacrylate, ethyl methacrylate and
E.1.2 1 to 50 wt. % of vinyl cyanides, in particular unsaturated nitriles such as acrylonitrile and methacrylonitrile, and/or (meth)acrylic acid (C₁-C₈) alkyl esters, in particular methyl methacrylate, glycidyl methacrylate, n-butyl acrylate, t-butyl acrylate, and/or derivatives, in particular anhydrides and imides of unsaturated carboxylic acids, in particular maleic anhydride or N-phenyl maleimide, the percentages by weight being based on 100 wt.-% elastomer modifier.

Preferred monomers E.1.1 are to be selected from at least one of the monomers styrene, α-methyl styrene and methyl methacrylate, preferred monomers E.1.2 are selected from at least one of the monomers acrylonitrile, maleic anhydride, glycidyl methacrylate and methyl methacrylate. Particularly preferred monomers are E.1.1 styrene and E.1.2 acrylonitrile.

Suitable grafting bases E.2 for graft polymers to be used in elastomer modifiers are, for example, diene rubbers, EPDM rubbers, i.e. those based on ethylene/propylene and optionally diene, further acrylate, polyurethane, silicone, chloroprene and ethylene/vinyl acetate rubbers. EPDM stands for ethylene-propylene-diene rubber.

Preferred grafting bases E.2 are diene rubbers, in particular based on butadiene, isoprene, etc., or mixtures of diene rubbers or copolymers of diene rubbers or mixtures thereof with further copolymerizable monomers, in particular according to E.1.1 and E.1.2, with the proviso that the glass transition temperature of component E.2 is <10° C., preferably <0° C., particularly preferably <−10° C.

Particularly preferred grafting bases E.2 are ABS polymers (emulsion, bulk and suspension ABS), where ABS stands for acrylonitrile-butadiene-styrene, as described, for example, in DE-A 2 035 390 or DE-A 2 248 242 or in Ullmann, Encyclopedia of Technical Chemistry, Vol. 19 (1980), p. 277-295. The gel content of the grafting base E.2 is preferably at least 30% by weight, particularly preferably at least 40% by weight (measured in toluene).

The elastomer modifiers or graft polymers to be used as component E) are prepared by radical polymerization, preferably by emulsion, suspension, solution or bulk polymerization, in particular by emulsion or bulk polymerization.

Particularly suitable graft rubbers are also ABS polymers prepared by redox initiation with an initiator system of organic hydroperoxide and ascorbic acid according to U.S. Pat. No. 4,937,285.

Since, as is known, the grafting monomers are not necessarily completely grafted onto the grafting base during the grafting reaction, graft polymers according to the invention also include those products which are obtained by (co)polymerization of the grafting monomers in the presence of the grafting base and are produced during the work-up.

Also suitable acrylate rubbers are based on graft bases E.2 which are preferably polymers of acrylic acid alkyl esters, optionally with up to 40% by weight, based on E.2, of other polymerizable ethylenically unsaturated monomers. Preferred polymerizable acrylic acid alkyl esters include C₁-C₈ alkyl esters, preferably methyl, ethyl, butyl, n-octyl and 2-ethylhexyl esters; haloalkyl esters, preferably halo-C₁-C₈ alkyl esters, such as chloroethyl acrylate, glycidyl esters and mixtures of these monomers. In this context, graft polymers with butyl acrylate as the core and methyl methacrylates as the shell, in particular. Paraloid® EXL2300, Dow Corning Corporation, Midland Michigan, USA, are particularly preferred.

For crosslinking, monomers with more than one polymerizable double bond can be copolymerized as an alternative to ethylenically unsaturated monomers. Preferred crosslinking monomers are esters of unsaturated monocarboxylic acids with 3 to 8 C atoms and unsaturated monohydric alcohols with 3 to 12 C atoms, or saturated polyols with 2 to 4 OH groups and 2 to 20 C atoms, preferably ethylene glycol dimethacrylate, allyl methacrylate; polyunsaturated heterocyclic compounds, preferably trivinyl and triallyl cyanurate; polyfunctional vinyl compounds, preferably di- and trivinylbenzenes; but also triallyl phosphate and diallyl phthalate.

Particularly preferred crosslinking monomers are allyl methacrylate, ethylene glycol dimethacrylate, diallyl phthalate and heterocyclic compounds containing at least 3 ethylenically unsaturated groups.

Very particularly preferred crosslinking monomers are the cyclic monomers triallyl cyanurate, triallyl isocyanurate, triacryloylhexahydro-s-triazine, triallylbenzenes. The amount of the crosslinked monomers is preferably 0.02 to 5% by weight, in particular 0.05 to 2% by weight, based on the grafting base E.2.

In the case of cyclic crosslinking monomers with at least 3 ethylenically unsaturated groups, it is advantageous to limit the amount to below 1 wt. % of the grafting base E.2.

Preferred “other” polymerizable, ethylenically unsaturated monomers which, in addition to the acrylic acid esters, can optionally serve to prepare the graft base E.2 are acrylonitrile, styrene, α-methylstyrene, acrylamides, vinyl C₁-C₆-alkyl ether, methyl methacrylate, glycidyl methacrylate, butadiene. Preferred acrylate rubbers as grafting base E.2 are emulsion polymers having a gel content of at least 60% by weight.

Other preferably suitable grafting bases according to E.2 are silicone rubbers with grafting active sites as described in DE-A 3 704 657, DE-A 3 704 655, DE-A 3 631 540 and DE-A 3 631 539.

Preferred graft polymers with a silicone content are those comprising methyl methacrylate or styrene acrylonitrile as shell and a silicone/acrylate graft as core. Preferred styrene acrylonitrile to be used as shell is Metablen® SRK200. Preferred methyl methacrylate to be used as shell is Metablen® S2001 or Metablen® S2030 or Metablen® SX-005. Particularly preferred to be used is Metablen® S2001. The products with the trade name Metablen® are available from Mitsubishi Rayon Co., Ltd., Tokyo, Japan.

Monomers with more than one polymerizable double bond can be copolymerized for crosslinking. Preferred examples of crosslinking monomers are esters of unsaturated monocarboxylic acids with 3 to 8 C atoms and unsaturated monohydric alcohols with 3 to 12 C atoms, or saturated polyols with 2 to 4 OH groups and 2 to 20 C atoms, preferably ethylene glycol dimethacrylate, allyl methacrylate; polyunsaturated heterocyclic compounds, preferably trivinyl and triallyl cyanurate; polyfunctional vinyl compounds, preferably di- and trivinylbenzenes; but also triallyl phosphate and diallyl phthalate.

Preferred crosslinking monomers are allyl methacrylate, ethylene glycol dimethacrylate, diallyl phthalate and heterocyclic compounds having at least 3 ethylenically unsaturated groups.

Particularly preferred crosslinking monomers are the cyclic monomers triallyl cyanurate, triallyl isocyanurate, triacryloylhexahydro-s-triazine, triallylbenzenes. The amount of the crosslinked monomers is preferably 0.02 to 5% by weight, in particular 0.05 to 2% by weight, based on the grafting base E.2.

In the case of cyclic crosslinking monomers with at least 3 ethylenically unsaturated groups, it is advantageous to limit the amount to less than 1% by weight of the grafting base E.2.

Preferred “other” polymerizable, ethylenically unsaturated monomers which, in addition to the acrylic acid esters, can optionally serve to prepare the grafting base E.2 are acrylonitrile, styrene, α-methylstyrene, acrylamides, vinyl C₁-C₆-alkyl ether, methyl methacrylate, glycidyl methacrylate, butadiene. Preferred acrylate rubbers as grafting base E.2 are emulsion polymers having a gel content of at least 60% by weight.

In addition to elastomer modifiers based on graft polymers, elastomer modifiers not based on graft polymers can also be used, which have glass transition temperatures <10° C., preferably <0° C., particularly preferably <−20° C. Preferably, these include elastomers with a block copolymer structure and also thermoplastically fusible elastomers, in particular EPM, EPDM and/or SEBS rubbers (EPM=ethylene-propylene copolymer, EPDM=ethylene-propylene-diene rubber and SEBS=styrene-ethylene-butene-styrene copolymer).

The lubricants -and/or mold release agents to be used as component E) are preferably long-chain fatty acids, in particular stearic acid or behenic acid, their salts, in particular Ca -or Zn stearate, -and their ester derivatives, in particular those based on pentaerythritol, in particular fatty acid esters of pentaerythritol or amide derivatives, in particular ethylene-bis-stearyl amide, montan waxes and low-molecular polyethylene -or polypropylene waxes.

Montan waxes in the sense of the present invention are mixtures of straight-chain, saturated carboxylic acids with chain lengths of 28 to 32 carbon-atoms.

In accordance with the invention, preferably used as lubricants and/or mold release agents are those from the group of esters of saturated or unsaturated aliphatic carboxylic acids having 8 to 40 carbon atoms with aliphatic saturated alcohols or amides of amines having 2 to 40 carbon atoms with unsaturated aliphatic carboxylic acids having 8 to 40 carbon atoms or instead of the carboxylic acids the metal salts of saturated or unsaturated aliphatic carboxylic acids having 8 to 40 carbon atoms.

Particularly preferred lubricants and/or mold release agents to be used as component E) are selected from the group consisting of pentaerythritol tetrastearate [CAS No. 115-83-3], ethylene bis-stearyl amide, calcium stearate and ethylene glycol dimontanate. In particular, calcium stearate [CAS No. 1592-23-0] or ethylene-bis-stearylamide [CAS No. 110-30-5] is preferably used. In particular, ethylene-bis-stearylamide (Loxiol® EBS from Emery Oleochemicals) is especially preferred.

Preferred components to be used as component E) for reducing water absorption are polyesters, polybutylene terephthalate and/or polyethylene terephthalate being preferred and polyethylene terephthalate being particularly preferred. The polyesters are preferably used in concentrations of 5 to 20% by weight and particularly preferably in concentrations of 7 to 15% by weight, in each case based on the total polymer composition and with the proviso that the sum of all percentages by weight of the polymer composition is always 100% by weight.

Other flame retardants to be used preferably as component E) are, different from component B) and C), different mineral flame retardants, nitrogen-containing flame retardants or phosphorus-containing flame retardants.

In an alternative embodiment—if the need so requires, taking into account the disadvantages due to the loss of laser transparency—flame retardants may be used which as laser absorbers have a negative effect on the laser transmission of a product based on polymer compositions according to the invention.

Among the mineral flame retardants, magnesium hydroxide is particularly preferred. Magnesium hydroxide [CAS No. 1309-42-8] may be contaminated due to its origin and method of manufacture. Typical impurities are, for example, species containing silicon, iron, calcium and/or aluminum, which may be incorporated in the magnesium hydroxide crystals, for example in the form of oxides. The magnesium hydroxide to be used as a mineral flame retardant can be uncoated or coated. Preferably, the magnesium hydroxide to be used as mineral flame retardant is provided with sizings based on stearates or aminosiloxanes, particularly preferably with aminosiloxanes. Preferably, magnesium hydroxide to be used as a mineral flame retardant has a mean particle size d50 in the range from 0.5 μm to 6 μm, to be determined by laser diffraction in accordance with ISO 13320, a d50 in the range from 0.7 μm to 3.8 μm being preferred and a d50 in the range from 1.0 μm to 2.6 μm being particularly preferred.

Mineral flame retardants to be used as component E) according to the invention are suitable magnesium hydroxide grades, in particular Magnifin® H5IV from Martinswerk GmbH, Bergheim, Germany or Hidromag® Q2015 TC from Penoles, Mexico City, Mexico.

Preferred nitrogen-containing flame retardants to be used as component E) are the reaction products of trichlorotriazine, piperazine and morpholine according to CAS No. 1078142-02-5, in particular MCA PPM Triazine HF from MCA Technologies GmbH, Biel-Benken, Switzerland, furthermore melamine cyanurate and condensation products of melamine, in particular melem, melam, melon or higher-condensation compounds of this type. Preferred inorganic nitrogen-containing compounds are ammonium salts.

Furthermore, salts of aliphatic and aromatic sulfonic acids and mineral flame retardant additives, in particular aluminum hydroxide or Ca—Mg carbonate hydrates (DE-A 4 236 122) can be used as flame retardants to be used as component E).

Flame retardant synergists from the group of oxygen, nitrogen or sulfur-containing metal compounds are also suitable for use as flame retardants of component E). Preferred compounds are zinc-free compounds, in particular molybdenum oxide, magnesium oxide, magnesium carbonate, calcium carbonate, calcium oxide, titanium nitride, magnesium nitride, calcium phosphate, calcium borate, magnesium borate or mixtures thereof.

In an alternative embodiment, however, zinc-containing compounds can also be used as flame retardants of component E) if required. These preferably include zinc oxide, zinc borate, zinc stannate, zinc hydroxystannate, zinc sulfide and zinc nitride, or mixtures thereof.

In an alternative embodiment, however, calcium stannate, calcium hydroxystannate can also be used as flame retardants of component E), if required.

However, aluminum salts of phosphonic acid are also preferably used as flame retardants to be used as component E). According to Wikipedia, phosphonic acid is the substance with the empirical formula H₃PO₃ [CAS No. 13598-36-2] (http://de.wikipedia.org/wiki/Phosphons%C3%A4ure). The salts of phosphonic acid are called phosphonates. Phosphonic acid can exist in two tautomeric forms, one having a free pair of electrons on the phosphorus atom and the other having a double bonded oxygen to the phosphorus (P═O). The tautomeric equilibrium is entirely on the side of the form with the doubly bonded oxygen. According to A. F. Holleman, E. Wiberg: Textbook of Inorganic Chemistry. 101st ed. Walter de Gruyter, Berlin/New York 1995, ISBN 3-11-012641-9, p. 764, the terms “phosphorous acid” or “phosphites” should be used only for the tautomeric species with a free electron pair on the phosphorus. In the past, however, the terms “phosphorous acid” or “phosphites” were also used for the tautomeric forms with double-bonded oxygen to the phosphorus, so that in the present invention the terms phosphonic acid and phosphorous acid or phosphonates and phosphites are used synonymously with each other.

Preferably, as aluminum salts of phosphonic acid, at least one is used selected from the group consisting of
Primary aluminum phosphonate [Al(H₂PO₃)₃],
basic aluminum phosphonate [Al(OH)H₂PO₃)₂.2H₂O],
Al₂(HPO₃)₃.x Al₂O₃.n H₂O with x ranging from 2.27 to 1 and n ranging from 0 to 4,
Al₂(HPO₃)₃.(H₂O)_{q} of formula (V) wherein q is 0, 1, 2, 3 or 4, in particular aluminum phosphonate tetrahydrate [Al₂(HPO₃)₃.4H₂O] or secondary aluminum phosphonate [Al₂(HPO₃)₃],
Al₂M_{z}(HPO₃)_{y}(OH)ᵥ.(H₂O)_{w} of the formula (VI) wherein M is alkali metal ion(s) and z ranges from 0.01 to 1.5, y ranges from 2.63-3.5, v ranges from 0 to 2 and w ranges from 0 to 4, and
Al₂(HPO₃)ᵤ(H₂PO₃)ₜ.(H₂O)ₛ of formula (VII) wherein u ranges from 2 to 2.99, t ranges from 2 to 0.01, and s ranges from 0 to 4,
where, in formula (VI), z, y and v and, in formula (VII), u and t can represent only such numbers that the corresponding aluminum salt of the phosphonic acid is uncharged as a whole.

Preferred alkali metals in formula (VI) are sodium and potassium.

The described aluminum salts of phosphonic acid exhibit high laser transmission in polyamides and can be used individually or in a mixture.

Particularly preferred aluminum salts of phosphonic acid are selected from the group consisting of.

Primary aluminum phosphonate [Al(H₂PO₃)₃],

Secondary aluminum phosphonate [Al₂(HPO₃)₃],

basic aluminum phosphonate [Al(OH)H₂PO₃)₂.2H₂O],

Aluminum phosphonate tetrahydrate [Al₂(HPO₃)₃.4H₂O] and

Al₂(HPO₃)₃.xAl₂O₃.n H₂O with x ranging from 2.27 to 1 and n ranging from 0 to 4.

Most preferred are secondary aluminum phosphonate [Al₂(HPO₃)₃], CAS No. 71449-76-8] and secondary aluminum phosphonate tetrahydrate [Al₂(HPO₃)₃.4H₂O], CAS No. 156024-71-4], especially preferred is secondary aluminum phosphonate [Al₂(HPO₃)₃].

Preferred further phosphorus-containing flame retardants different from component B) and C) are further organic metal phosphinates, red phosphorus, inorganic metal hypophosphites, further metal phosphonates, derivatives of 9,10-dihydro-9-oxa-10-phosphaphenanthrene-10-oxides (DOPO derivatives), resorcinol bis(diphenyl phosphate) (RDP) including oligomers, bisphenol A bis-diphenyl phosphate (BDP), including oligomers, 4,4′-biphenyl bis(diphenyl phosphates), melamine pyrophosphate, melamine poly(aluminum phosphate), melamine poly(zinc phosphate) or phenoxyphosphazene oligomers and mixtures thereof.

Other flame retardants to be used as component E) are carbon formers, particularly preferably phenol-formaldehyde resins, polycarbonates, polyimides, polysulfones, polyether sulfones or polyether ketones, and anti-drip agents, especially tetrafluoroethylene polymers.

The flame retardants to be used as component E) can be added in pure form, as well as via masterbatches or compactates.

In an alternative embodiment, however, halogen-containing flame retardants can also be used as flame retardants—if the need so requires, taking into account the disadvantages caused, among other things, by the loss of halogen-freedom of the flame retardants. Preferred halogen-containing flame retardants are commercially available organic halogen compounds, particularly preferred ethylene-1,2-bistetrabromophthalimide, decabromodiphenylethane, tetrabromobisphenol-A-epoxyoligomer, tetrabromobisphenol-A-oligocarbonate, tetrachlorobisphenol-A-oligocarbonate, polypentabromobenzyl acrylate, brominated polystyrene or brominated polyphenylene ethers, which can be used alone or in combination with synergists, in particular antimony trioxide or antimony pentoxide, brominated polystyrene being particularly preferred among the halogen-containing flame retardants. Brominated polystyrene is preferably used at 10-30% by weight, particularly preferably at 15-25% by weight, in each case based on the total composition, wherein at least one of the other components is reduced to such an extent that the sum of all the percentages by weight is always 100.

Brominated polystyrene is commercially available in various product grades. Examples include Firemaster® PBS64 from the firm Lanxess, Cologne, Germany, and Saytex® HP-3010 from the firm Albemarle, Baton Rouge, USA.

In the case of a laser-absorbing component, at least one laser absorber selected from the group of antimony trioxide, tin oxide, tin orthophosphate, barium titanate, aluminum oxide, copper hydroxyphosphate, copper orthophosphate, potassium copper diphosphate, copper hydroxide, antimony tin oxide, bismuth trioxide, and antraquinone can be used as component E) while losing the property of high laser transmission. Tin oxide, antimony trioxide or antimony tin oxide are particularly preferred. Antimony trioxide is particularly preferred.

The laser absorber, in particular the antimony trioxide, can be used directly as a powder or in the form of masterbatches. Preferred masterbatches are those based on polyamide and/or polyolefins, preferably polyethylene. Very preferably, antimony trioxide is used in the form of a polyamide 6-based masterbatch.

The laser absorber can be used individually or as a mixture of several laser absorbers.

Laser absorbers can absorb laser light of a specific wavelength. In practice, this wavelength is in the range from 157 nm to 10.6 μm. Examples of lasers of these wavelengths are described in WO2009/003976 A1. Nd:YAG lasers, with which wavelengths of 1064, 532, 355 and 266 nm can be realized, and CO₂ lasers are preferably used.

### Preferred Polymer Compositions

Particularly preferred are polymer compositions containing
A) per 100 parts by mass of polyamide 66,
B) 2 to 100 parts by mass, preferably 5 to 60 parts by mass, particularly preferably 7 to 40 parts by mass, especially preferably 8 to 20 parts by mass of aluminum methylphosphonate of the formula (Ia)

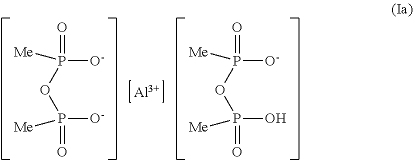

C) 5 to 120 parts by mass, preferably 7 to 80 parts by mass, particularly preferably 8 to 60 parts by mass, especially preferably 10 to 50 parts by mass of aluminum tris(diethylphosphinate), and
D) 3 to 300 parts by mass, preferably 5 to 200 parts by mass, particularly preferably to 15 to 120 parts by mass, especially preferably 20 to 90 parts by mass of glass fibers.

Very particularly preferred are polymer compositions containing
A) per 100 parts by mass of polyamide 66,
B) 2 to 100 parts by mass, preferably 5 to 60 parts by mass, particularly preferably 7 to 40 parts by mass, especially preferably 8 to 20 parts by mass of aluminum methylphosphonate of the formula (la)

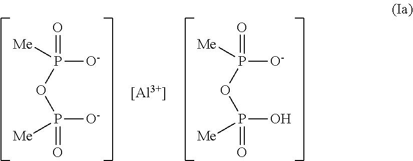

C) 5 to 120 parts by mass, preferably 7 to 80 parts by mass, particularly preferably 8 to 60 parts by mass, especially preferably 10 to 50 parts by mass of aluminum tris(diethylphosphinate),
D) 3 to 300 parts by mass, preferably 5 to 200 parts by mass, particularly preferably to 15 to 120 parts by mass, especially preferably 20 to 90 parts by mass of glass fibers, and
E) 0.01 to 30 parts by mass, preferably 0.1 to 15 parts by mass, particularly preferably 0.3 to 5 parts by mass, especially preferably 0.5 to 3 parts by mass of N,N′-1,6-hexanediylbis[3,5-bis(1,1-dimethylethyl)-4-hydroxyphenylpropanamide and/or ethylene-bis-stearylamide and/or talc.

Preferably, component C) is used in lower mass proportions than component B).

### Preferred Process Variants

Furthermore, it is a preferred subject-matter of the present invention to provide a method of manufacturing of manufacturing of products, preferably products for electromobility, for household appliances, and in the electronics and electrical fields, wherein the components
A) 100 parts by mass of polyamide 66 with
B) 2 to 100 parts by mass, preferably 5 to 60 parts by mass, particularly preferably 7 to 40 parts by mass, especially preferably 8 to 20 parts by mass of aluminum methylphosphonate of the formula (Ia)

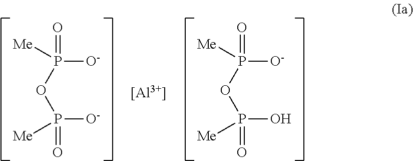

and
C) 5 to 120 parts by mass, preferably 7 to 80 parts by mass, particularly preferably 8 to 60 parts by mass, especially preferably 10 to 50 parts by mass of aluminum tris(diethylphosphinate),
   as well as with
D) 3 to 300 parts by mass, preferably 5 to 200 parts by mass, particularly preferably 15 to 120 parts by mass, especially preferably 20 to 90 parts by mass of glass fibers, and optionally with further additives are mixed or blended in at least one mixing unit and finally are processed by injection molding.

Preferably, the components are kneaded, compounded, extruded or rolled to form a molding compound. Preferably, this mixing is carried out at a temperature in the range from 270 to 300° C., particularly preferably by compounding on a co-rotating twin-screw extruder or Buss Kneader. It may be advantageous to pre-mix individual components.

A particularly preferred subject-matter of the present invention is a process for the manufacture for the manufacture of products, preferably products for electromobility, for household appliances and in the electronics and electrical sector, wherein the components A) 100 parts by mass of polyamide 66 with
B) 2 to 100 parts by mass, preferably 5 to 60 parts by mass, particularly preferably 7 to 40 parts by mass, especially preferably 8 to 20 parts by mass of aluminum methylphosphonate of the formula (la)

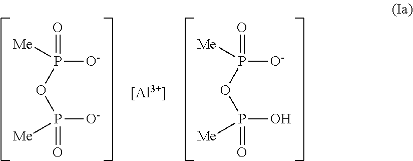

C) 5 to 120 parts by mass, preferably 7 to 80 parts by mass, particularly preferably 8 to 60 parts by mass, especially preferably 10 to 50 parts by mass of aluminum tris(diethylphosphinate),
D) 3 to 300 parts by mass, preferably 5 to 200 parts by mass, particularly preferably 15 to 120 parts by mass, especially preferably 20 to 90 parts by mass of glass fibers and with
E) 0.01 to 30 parts by mass, preferably 0.1 to 15 parts by mass, particularly preferably 0.3 to 5 parts by mass, especially preferably 0.5 to 3 parts by mass of N,N′-1,6-hexanediylbis[3,5-bis(1,1-dimethylethyl)-4-hydroxyphenylpropanamide and/or with ethylene-bis-stearylamide and/or with talc are mixed or blended in at least one mixing aggregate and finally processed by injection molding.

Preferably, component C) is used in lower mass proportions than component B).

The process of injection molding is characterized by the fact that the raw material, preferably in granular form, is melted (plasticized) in a heated cylindrical cavity and injected as an injection mass under pressure into a temperature-controlled cavity. After the compound has cooled (solidified), the injection molded part is demolded.

### One Distinguishes

1. plasticizing/melting
2. injection phase (filling process)
3. After pressure phase (due to thermal contraction during crystallization).
4. demolding.

An injection molding machine consists of a closing unit, the injection unit, the drive and the control system. The closing unit includes fixed and moving clamping plates for the mold, a faceplate, and columns and drive for the moving mold clamping plate. (Toggle joint or hydraulic sloding unit).

An injection unit comprises the electrically heated cylinder, the drive of the screw (motor, gearbox) and the hydraulics for moving the screw and injection unit. The task of the injection unit is to melt, meter, inject and repress (due to contraction) the powder or granules. The problem of backflow of the melt within the screw (leakage flow) is solved by non-return valves.

In the injection mold, the inflowing melt is then dissolved, cooled and thus the product to be manufactured is produced. This always requires two mold halves. In injection molding, a distinction is made between the following functional complexes:
gating system
Shaping inserts
Ventilation
Machine and force absorption
Demolding system and motion transmission
tempering

Consequently, the present invention also relates to products obtainable injection molding of the compositions according to the invention.

### Preferred Variants of Use

It is also a preferred subject-matter of the invention to use polymer compositions comprising
A) per 100 parts by mass of polyamide 66,
B) 2 to 100 parts by mass, preferably 5 to 60 parts by mass, particularly preferably 7 to 40 parts by mass, especially preferably 8 to 20 parts by mass, of at least one aluminum salt of the general formula (I)

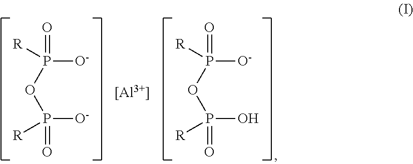

wherein R represents C₁-C₁₂ alkyl, preferably methyl, ethyl, isopropyl or iso-butyl, tert-butyl or n-butyl, more preferably ethyl or methyl, most preferably methyl, and
C) 5 to 120 parts by mass, preferably 7 to 80 parts by mass, particularly preferably 8 to 60 parts by mass, especially preferably 10 to 50 parts by mass of at least one organic phosphinic acid salt of the formula (II) and/or at least one diphosphinic acid salt of the formula (III) and/or polymers thereof,

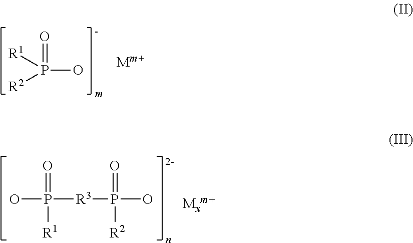

wherein
   R¹, R² are the same or different and represent a linear or branched C₁-C₆-alkyl, and/or C₆-C₁₄-aryl,
   R³ represents linear or branched C₁-C₁₀-alkylene, C₆-C₁₀-arylene or represents C₁-C₆-alkyl-C₆-C₁₀-arylene or C₆-C₁₀-aryl-C₁-C₆-alkylene,
   M represents aluminum, zinc or titanium,
   m represents an integer from 1 to 4;
   n represents an integer from 1 to 3,
   x represents 1 and 2,
   wherein n, x and m in formula (III) can simultaneously represent only such integers, that the diphosphinic acid salt of formula (III) as a whole is uncharged, and
D) 3 to 300 parts by mass, preferably 5 to 200 parts by mass, particularly preferably to 15 to 120 parts by mass, especially preferably 20 to 90 parts by mass of at least one filler and/or reinforcing material for the manufacture of products for use in motor vehicles, in components for the electrical and electronics industry or in household appliances.

Particularly preferred is the use of polymer compositions containing
A) per 100 parts by mass of polyamide 66,
B) 2 to 100 parts by mass, preferably 5 to 60 parts by mass, particularly preferably 7 to 40 parts by mass, especially preferably 8 to 20 parts by mass of aluminum methylphosphonate of the formula (Ia)

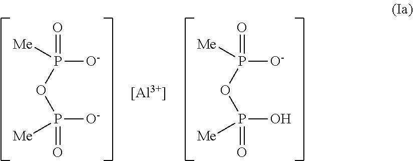

C) 5 to 120 parts by mass, preferably 7 to 80 parts by mass, particularly preferably 8 to 60 parts by mass, especially preferably 10 to 50 parts by mass of aluminum tris(diethylphosphinate), and
D) 3 to 300 parts by mass, preferably 5 to 200 parts by mass, particularly preferably to 15 to 120 parts by mass, especially preferably 20 to 90 parts by mass of glass fibers for the manufacture of products for use in motor vehicles, in components for the electrical and electronics industry or in household appliances.

Very particularly preferred is the use of polymer compositions containing
A) per 100 parts by mass of polyamide 66,
B) 2 to 100 parts by mass, preferably 5 to 60 parts by mass, particularly preferably 7 to 40 parts by mass, especially preferably 8 to 20 parts by mass of aluminum methylphosphonate of the formula (la)

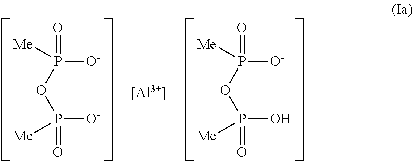

C) 5 to 120 parts by mass, preferably 7 to 80 parts by mass, particularly preferably 8 to 60 parts by mass, especially preferably 10 to 50 parts by mass of aluminum tris(diethylphosphinate),
D) 3 to 300 parts by mass, preferably 5 to 200 parts by mass, particularly preferably to 15 to 120 parts by mass, especially preferably 20 to 90 parts by mass of glass fibers, and
E) 0.01 to 30 parts by mass, preferably 0.1 to 15 parts by mass, particularly preferably 0.3 to 5 parts by mass, especially preferably 0.5 to 3 parts by mass of N,N′-1,6-hexanediylbis[3,5-bis(1,1-dimethylethyl)-4-hydroxyphenylpropanamide and/or ethylene-bis-stearylamide and/or talc for the manufacture of products for use in motor vehicles, in components for the electrical and electronics industry or in household appliances.

However, the present invention also relates to the use of from 2 to 100 parts by mass, preferably from 5 to 60 parts by mass, particularly preferably from 7 to 40 parts by mass, more preferably from 8 to 20 parts by mass of aluminum methylphosphonate of the formula (Ia)

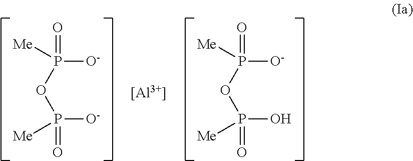

and 5 to 120 parts by mass, preferably 7 to 80 parts by mass, particularly preferably 8 to 60 parts by mass, especially preferably 10 to 50 parts by mass of aluminum tris(diethylphosphinate) and 3 to 300 parts by mass, preferably 5 to 200 parts by mass, particularly preferably 15 to 120 parts by mass, especially preferably 20 to 90 parts by mass of glass fibers, in each case based on 100 parts by mass of polyamide 66, for the production of laser-transparent compositions or products, preferably with a GWIT at 0.75 mm wall thickness of at least 775° C.

However, the present invention also relates to the use of from 2 to 100 parts by mass, preferably from 5 to 60 parts by mass, particularly preferably from 7 to 40 parts by mass, more preferably from 8 to 20 parts by mass of aluminum methylphosphonate of the formula (Ia)

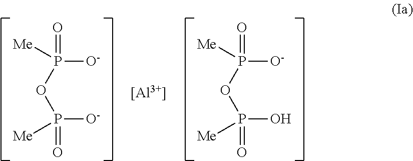

and 5 to 120 parts by mass, preferably 7 to 80 parts by mass, particularly preferably 8 to 60 parts by mass, especially preferably 10 to 50 parts by mass of aluminum tris(diethylphosphinate), 3 to 300 parts by mass, preferably 5 to 200 parts by mass, particularly preferably to 15 to 120 parts by mass, especially preferably 20 to 90 parts by mass of glass fibers and 0.01 to 30 parts by mass, preferably 0,1 to 15 parts by mass, particularly preferably 0.3 to 5 parts by mass, especially preferably 0.5 to 3 parts by mass of N,N′-1,6-hexanediylbis[3,5-bis(1,1-dimethylethyl)-4-hydroxyphenylpropanamide and/or ethylene-bis-stearylamide, in each case based on 100 parts by mass of polyamide 66, for the production of laser-transparent compositions or products, preferably with a GWIT at 0.75 mm wall thicknesses of at least 775° C.

Preferably, component C) is used in lower mass proportions than component B).

### EXAMPLES

For proof of the improvements in properties described in accordance with the invention, respective polyamide 66-based polymer compositions were first prepared by compounding. For this purpose, the individual components according to Tab. I were mixed in a twin-screw extruder (ZSK 25 compounder from Coperion Werner & Pfleiderer (Stuttgart, Germany)) at temperatures in the range of 270 to 300° C., discharged as a strand, cooled until being pelletizable and pelletized, with the glass fibers being added with the aid of a side extruder in the rear (near-nozzle) section of the extruder. After drying (usually for two days at 80° C. in a vacuum drying oven), the granules were processes by injection molding at temperatures in the range of 270 to 290° C. to produce standard test specimens for the respective tests, wherein an Arburg 320-210-500 injection molding machine was used for injection molding.

### Process for the Preparation of the Aluminum Methylphosphonate Used as Component B)

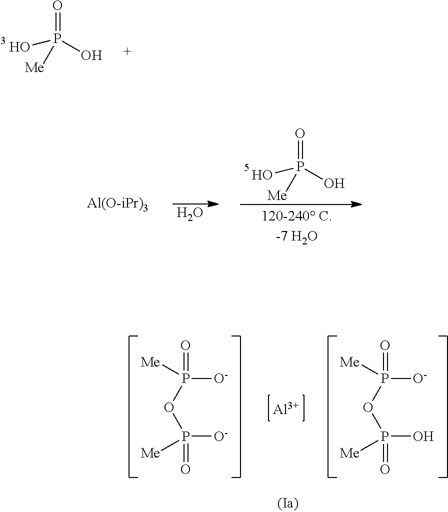

A reaction vessel was charged with 83 g methylphosphonic acid and heated to 120° C. An intermediate prepared from 50 g methylphosphonic acid and 35.4 g aluminum tris(isopropoxide) was added to the reaction vessel in the presence of water. The resulting solution, which contained methylphosphonic acid and aluminum methylphosphonate in a molar ratio of 5:1 as intermediates, was heated to 240° C. with mechanical stirring. Stirring was continued at 240° C. for about 30 minutes until a solid was formed. Then, 500 ml of water was added and this mixture was stirred for 16 h, meanwhile a uniform slurry was formed. The product was finally filtered off, washed with 750 ml and dried. The result was 64.3 g of the product of formula (Ia) to be used as component B) as fine colorless crystals in a yield of 93%.

The glow wire resistance was determined using the glow wire ignition temperature (GWIT) test according to DIN EN 60695-2-13. The GWIT test specifies the glow-wire ignition temperature that is 25K (or 30K for temperatures in the range 900° C. to 960° C.) higher than the maximum glow-wire temperature that does not lead to ignition in 3 consecutive tests, even during the exposure time of the glow wire. Ignition is considered to be a flame with burning time 5 sec. Round plates with a diameter of 80 mm and a thickness of 0.75 mm were used for the tests. In Table I, the actual burning time at a test temperature of 750° C. is additionally given as the “GWIT burning time”, irrespective of the maximum GWIT classification achieved. Here, each the highest individual firing time of the firing times determined in the 3 successive tests is listed.

The laser transparency of the samples investigated in the present invention was measured in accordance with DVS Guideline 2243 (01/2014) “Laser beam welding of thermoplastics” using round plates with a diameter of 80 mm and a thickness of 0.75 mm in the near infrared (NIR) with the LPKF TMG3 transmission measuring device from the firm LPKF Laser & Electronics AG, Garbsen, Germany, which was previously calibrated with a measurement standard generated according to DIN EN ISO/IEC 17025, at a laser wavelength of 980 nm; see: LPKF AG 101016-EN: “Simple transmission measurement for plastics LPKF TMG3”.

The flame resistance of the test specimens with dimensions of 125 mm-13 mm-0.75 mm was determined according to the UL94V method (Underwriters Laboratories Inc. Standard of Safety, “Test for Flammability of Plastic Materials for Parts in Devices and Appliances”, p. 14-18 Northbrook 1998).

The impact strength according to IZOD was obtained according to ISO180-A on test specimens of the dimension 80 mm-10 mm-4 mm.

### Educts

Component A): Polyamide 66 (Torzen U3501 NC01, Invista, Wichita, USA) with a viscosity number of 126 ml/g measured according to ISO 307 in 0.5 wt % solution in 96 wt % sulfuric acid at 25° C.,
Component B): aluminum methyl phosphonate of the formula (Ia)
Component C): Aluminum tris(diethyl phosphinate), [CAS No. 225789-38-8] (Exolit® OP1230 from the firm Clariant SE, Muttenz, Switzerland),
Component D): chopped glass fiber CS 7997D from the firm Lanxess Deutschland GmbH, Cologne, Germany [mean fiber diameter 10 μm, mean fiber length 4.5 mm, E-glass (DIN 1259), silane coated],

TABLE I

| Educts | | Ex. 1 |
|---|---|---|
| Component A/1 | [mass | 100 |
| | fraction] | |
| Component B/1 | [mass | 17.1 |
| | fraction] | |
| Component C/1 | [mass | 41.1 |
| | fraction] | |
| Component D/1 | [mass | 68.5 |
| | fraction] | |
| UL94 at 0.75 mm | [Class] | V0 |
| GWIT at 0.75 mm | [° C.] | ≥775 |
| GWIT firing time at 750° C. | [s] | 0 |
| IZOD | [kJ/m²] | >55 |
| LPKF laser transmission | [%] | ≥45 |

Data of the components in Tab. I in mass fractions based on 100 mass fractions of component A1

Tab. I shows that Example 1 according to the invention achieves a VO classification in the UL94 test for wall thicknesses of 0.75 mm and also achieves a high GWIT of at least 775° C., whereby the burning time at a glow wire temperature is 0 seconds, i.e. beyond the requirement of the DIN EN 60695-2-13 standard there is no ignition at all.

Added to this is an excellent laser transparency of at least 45% and an impact strength of at least 45 kJ/m² determined in accordance with DIN EN ISO 180.

1. Polymer compositions containing
A) per 100 parts by mass of polyamide 66,
B) 2 to 100 parts by mass of at least one aluminum salt of the general formula (I) 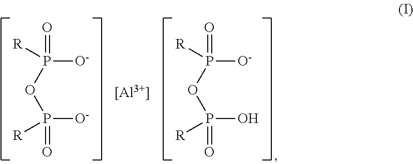
wherein R is C₁-C₁₂ alkyl,
C) 5 to 120 parts by mass of at least one organic phosphinic acid salt of the formula (II) and/or at least one diphosphinic acid salt of the formula (III) and/or polymers thereof, 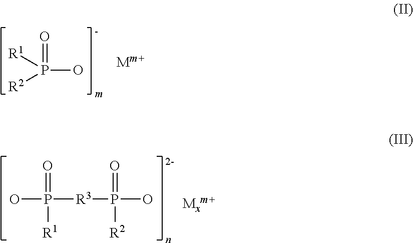
wherein
R¹, R² are the same or different and represent a linear or branched C₁-C₆-alkyl, and/or C₆-C₁₄-aryl,
R³ represents a linear or branched C₁-C₁₀-alkylene, C₆-C₁₀-arylene or a C₁-C₆-alkyl-C₆-C₁₀-arylene or C₆-C₁₀-aryl-C₁-C₆-alkylene,
M represents aluminum, zinc or titanium,
m represents an integer from 1 to 4;
n represents an integer from 1 to 3,
x represents 1 and 2,
wherein n, x and m in formula (III) can simultaneously represent only such integers, that the diphosphinic acid salt of formula (III) as a whole is uncharged, and
D) 3 to 300 parts by mass of at least one filler and/or reinforcing material.

2. Polymer compositions according to claim 1, characterized in that R in formula (I) represents methyl, ethyl, isopropyl or iso-butyl, tert-butyl or n-butyl, preferably ethyl or methyl, particularly preferably methyl.

3. Polymer compositions according to claim 1, characterized in that M in the formulae (II) or (III) represents aluminum.

4. Polymer compositions according to claim 1, characterized in that R¹, R² in formulae (II) and (III) are identical or different and represent C₁-C₆-alkyl, linear or branched, and/or phenyl.

5. Polymer compositions according to claim 1, characterized in that R¹, R² in the formulae (II) and (III) are identical or different and represent methyl, ethyl, n-propyl, iso-propyl, n-butyl, tert-butyl, n-pentyl and/or phenyl.

6. Polymer compositions according to claim 1, characterized in that R³ in formula (III) represents methylene, ethylene, n-propylene, iso-propylene, n-butylene, tert-butylene, n-pentylene, n-octylene, n-dodecylene, phenylene, naphthylene, methyl-phenylene, ethylphenylene, tert-butylphenylene, methylnaphthylene, ethylnaphthylene, tert-butylnaphthylene, phenylmethylene, phenylethylene, phenylpropylene or phenylbutylene, preferably phenylene or naphthylene.

7. Polymer compositions according to claim 1, characterized in that m in formula (II) represents 2 and 3, particularly preferably 3.

8. Polymer compositions according to claim 1, characterized in that n in formula (III) represents 1 and 3, particularly preferably 3.

9. Polymer compositions according to claim 1, characterized in that x in formula (III) represents 1 and 2, particularly preferably 2.

10. Polymer compositions according to claim 1, characterized in that aluminum tris(diethylphosphinate) is used as component C).

11. Polymer compositions according to claim 1, characterized in that glass, preferably glass according to DIN1259-1, particularly preferably glass as full glass spheres or hollow glass spheres, glass fibers, ground glass or aluminum borosilicate glass with an alkali content of 1% (E-glass), particularly as glass fibers, is used as component D).

12. Polymer compositions according to claim 1, characterized in that component C) is used in lower mass fractions than component B).

13. Products, in particular products for electromobility, for household appliances and in the electronics and electrical sector, based on polymer compositions according to claim 1.

14. Process for the production of products, characterized in that
component A) 100 parts by mass of polyamide 66 is mixed or blended with
B) 2 to 100 parts by mass of at least one aluminum salt of the general formula (I) 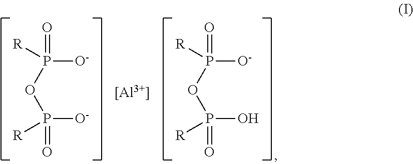
wherein R represents C₁-C₁₂ alkyl, and
C) 5 to 120 parts by mass of at least one organic phosphinic acid salt of the formula (II) and/or at least one diphosphinic acid salt of the formula (III) and/or polymers thereof, 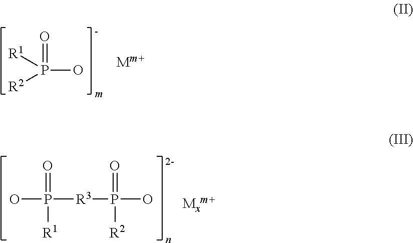
wherein
R¹, R² are the same or different and represent a linear or branched C₁-C₆-alkyl, and/or C₆-C₁₄-aryl,
R³ represents linear or branched C₁-C₁₀-alkylene, C₆-C₁₀-arylene or represents C₁-C₆-alkyl-C₆-C₁₀-arylene or C₆-C₁₀-aryl-C₁-C₁₀-alkylene,
M represents aluminum, zinc or titanium,
m represents an integer from 1 to 4;
n represents an integer from 1 to 3,
x represents 1 and 2,
wherein n, x and m in formula (III) can simultaneously represent only such integers, that the diphosphinic acid salt of formula (III) as a whole is uncharged, and
D) 3 to 300 parts by mass of at least one filler and/or reinforcing material
and optionally with further additives in at least one mixing unit and is finally processed by injection molding.

15. Use of 2 to 100 parts by mass of at least one aluminum salt of the general formula (I) 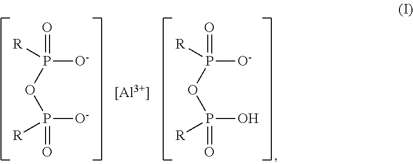
wherein R is C₁-C₁₂ alkyl, and
5 to 120 parts by mass of at least one organic phosphinic acid salt of the formula (II) and/or at least one diphosphinic acid salt of the formula (III) and/or polymers thereof, 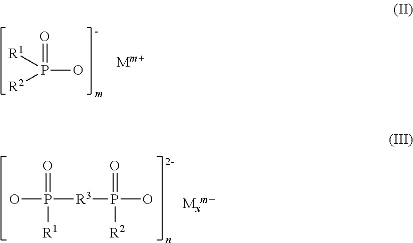
wherein
R¹, R² are the same or different and represent a linear or branched C₁-C₆-alkyl, and/or C₆-C₁₄-aryl,
R³ represents linear or branched C₁-C₁₀-alkylene, C₆-C₁₀-arylene or represents C1-C₆-alkyl-C₆-C₁₀-arylene or C₆-C₁₀-aryl-C₁-C₆-alkylene,
M represents aluminum, zinc or titanium,
m represents an integer from 1 to 4;
n represents an integer from 1 to 3,
x represents 1 and 2,
where n, x and m in formula (III) can simultaneously represent only such integers that the diphosphinic acid salt of the formula (III) as a whole is uncharged, in each case based on 100 parts by mass of polyamide 66 reinforced with 3 to 300 parts by mass of at least one filler and/or reinforcing material, for the production of laser-transparent compositions or products.

16. Use according to claim 15, characterized in that the laser-transparent compositions or articles further have a GWIT at 0.75 mm wall thicknesses of at least 775° C.
